(19) United States
(12) Patent Application Publication
(10) Pub. No.: US 2026/0323456 A1
(43) Pub. Date: Oct. 15, 2026

(54) Enhanced Cell Reselection Procedure Supporting Network Energy Saving

(71) Applicant: GOOGLE LLC, Mountain View, CA (US)

(72) Inventors: Ming-Hung Tao, Taoyuan City (TW); Chih-Hsiang Wu, Taoyuan City (TW)

(21) Appl. No.: 19/483,597

(22) PCT Filed: May 13, 2024
(86) PCT No.: PCT/US2024/029171

§ 371 Date: Nov. 11, 2025

Related U.S. Application Data
(60) Provisional application No. 63/501,675, filed on May 11, 2023.

(51) Int. Cl. H04W 36/30; H04W 36/00; H04W 36/16; H04W 52/36

(52) U.S. Cl. CPC H04W 36/30; H04W 36/0085; H04W 36/165; H04W 52/36

(57) ABSTRACT

To perform cell reselection, a user equipment (UE) receives (1806), from a radio access network (RAN), a network energy saving (NES) offset value corresponding to an adjustment in a signal measurement quantity for the cell reselection; performs (1816), in an idle state of a radio connection between the UE and the RAN, measurements on a plurality of candidate cells; and performs (1818) the cell reselection based on the measurements and the offset value.

### CROSS-REFERENCE TO RELATED APPLICATION

This application claims priority to and the benefit of the filing date of provisional U.S. Patent Application No. 63/501,675 entitled “Enhanced Cell Reselection Procedure Supporting Network Energy Saving,” filed on May 11, 2023. The entire content of the provisional application is hereby expressly incorporated herein by reference.

### FIELD OF THE DISCLOSURE

This disclosure relates generally to wireless communications and, more particularly, to enabling the network energy saving feature for a base station and allowing the user equipment (UE) to camp in time on another base station without enabling the network energy saving feature.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The objectives behind developing the fifth generation (5G) technology include providing a unified framework for such types of communication as enhanced mobile broadband (eMBB), ultra-reliable low-latency communications (URLLC), and massive machine type communication (mMTC).

Network energy saving is important for environmental sustainability because it can reduce environmental impact (e.g., greenhouse gas emissions) and is beneficial for operational cost savings. As 5G covers more and more types of communications and territories, handling more advanced services and applications requires higher data rates. As a result, networks need to be deployed in a dense manner, using more antennas, larger bandwidths and more frequency bands. The environmental impact of 5G needs requires proper control, and advanced solutions for improving network energy savings need to be developed.

Energy consumption has become a key component of the operators' operating expense. Most of the energy consumption comes from the radio access network, especially from the Active Antenna Unit (AAU), while data centers and fiber transport account for a smaller portion. The power consumption of a radio access network primarily occurs due dynamic operations, when devices expend power during data transmission/reception, and due to static operations, when devices constantly expend power to maintain the necessary operation of the radio access, even when the data transmission/reception is not in progress.

The currently available techniques in time and frequency domains aim to reduce the power consumption by turning off some symbols/slots/frames on one or more carriers, and hence allow a BS to perform some micro/light/deep sleep. The techniques in spatial and power domains aim to reduce the power consumption of the transceiver chains and power amplifiers (PA) by turning off spatial elements, reduce transmission power, and/or increase the PA efficiency.

In these and other cases, the network power saving techniques in time and frequency domains may increase the latency for a UE to access the network, because allowing a base station to sleep results in the UE not always being able to communicate with the base station. This may be an unacceptable limitation for UEs with stringent data latency requirement, particularly when the base station has to sleep for a very long period of time, such as one or more hours. For those UEs unable to tolerate such a long network access latency, it is important to allow the UEs to reselect and camp on a cell that does not enable or currently use network power saving techniques, or at least has a minimal impact on those UEs that need to establish a radio connection with the RAN for data transmission and/or reception.

### SUMMARY

Generally speaking, the techniques of this disclosure allow an idle/inactive UE originally camping on a cell enabling the NES feature to reselect and camp on another cell properly and efficiently.

An example embodiment of these techniques is a method for cell reselection. The method is implemented in a user equipment (UE) and comprises receiving, from a radio access network (RAN), a network energy saving (NES) offset value corresponding to an adjustment in a signal measurement quantity for the cell reselection; performing, in an idle state of a radio connection between the UE and the RAN, measurements on a plurality of candidate cells; and performing the cell reselection based on the measurements and the offset value.

Another example embodiment provides a method for evaluating cell reselection criteria using a common NES offset, before the occurrence of a cell non-active period. The method is implemented in a UE and comprises: receiving, from a base station, a system information message indicating which neighbor cell(s) is/are operating in cell Discontinuous Transmission/Discontinuous Reception (DTX/DRX) mode; receiving, from the base station, a common NES offset via the system information message or via a dedicated radio resource control (RRC) message; starting to conduct measurement on the neighbor cell(s) before the serving cell enters a cell non-active period; and evaluating cell reselection criteria with the common NES offset applied to all the cells operating in the cell DTX/DRX mode.

Yet another example embodiment is a method for evaluating the cell reselection criteria using the cell-specific NES offsets, before the occurrence of a cell non-active period. The method is also implemented in a UE and comprises receiving, from a base station, information regarding which neighbor cell(s) is/are operating in cell DTX/DRX mode, via a system information message or via a dedicated RRC message; receiving, from the base station, a cell-specific NES offset for each cell operating in the cell DTX/DRX mode, via a system information message or via a dedicated RRC message; starting to conduct measurement on neighbor cell(s) before the serving cell enters a cell non-active period; and evaluating cell reselection criteria with each cell-specific NES offset applied to the associated/corresponding cell.

Still another example embodiment of these techniques is a UE comprising one or more processors and configured to implement one of the methods above.

### BRIEF DESCRIPTION OF THE DRAWINGS

FIG. 1A is a block diagram of an example wireless communication system in which a user device and a base station of this disclosure can implement the reselection techniques of this disclosure;

FIG. 1B is a block diagram of an example base station in which a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3A is a messaging diagram of an example scenario in which a UE evaluates cell reselection criteria by applying a common NES offset to all the cells operating in the cell DTX/DRX mode, after receiving a common message notifying of the occurrence of a cell non-active period;

FIG. 3B is a messaging diagram of an example scenario similar to that of FIG. 3A, but in which the UE receives a dedicated message notifying of the occurrence of a cell non-active period;

FIG. 3C is a messaging diagram of an example scenario in which a UE evaluates cell reselection criteria by applying a common NES offset to all the cells operating in the cell DTX/DRX mode, before the occurrence of a periodic cell non-active period;

FIG. 4A is a messaging diagram of an example scenario in which a UE evaluates cell reselection criteria by applying a cell-specific NES offset to the corresponding cell, after receiving a common message notifying of the occurrence of a cell non-active period;

FIG. 4B is a messaging diagram of an example scenario similar to that of FIG. 4A, but in which the UE receives a dedicated message notifying of the occurrence of a cell non-active period;

FIG. 4C is a messaging diagram of an example scenario in which a UE evaluates the cell reselection criteria by applying a cell-specific NES offset to the corresponding cell, before the occurrence of a periodic cell non-active period;

FIG. 5A is a messaging diagram of an example scenario which a UE evaluates the cell reselection criteria by accounting for when a cell will start its cell non-active period, after receiving a common message notifying of the occurrence of a cell non-active period;

FIG. 5B is a messaging diagram of an example scenario similar to that of FIG. 53A, but in which the UE receives a dedicated message notifying of the occurrence of a cell non-active period;

FIG. 5C is a messaging diagram of an example scenario in which a UE evaluates the cell reselection criteria by accounting for when a cell will start its cell non-active period, before the occurrence of a periodic cell non-active period;

FIG. 6A is a messaging diagram of an example scenario in which a UE determines whether to conduct a neighbor cell measurement, after receiving a common message notifying of the occurrence of a cell non-active period;

FIG. 6B is a messaging diagram of an example scenario in which a UE determines whether to conduct a neighbor cell measurement, before the occurrence of a periodic cell non-active period;

FIG. 7 is a messaging diagram of an example scenario in which a UE in the connected state triggers candidate cell evaluation for conditional handover (CHO) execution, based on the timing information provided in the CHO configuration;

FIG. 8 is a flow diagram of an example method for evaluating cell reselection criteria using a common NES offset, before the occurrence of a cell non-active period, which can be implemented in the UE of FIG. 1A;

FIG. 9 is a flow diagram of an example method for evaluating cell reselection criteria using cell-specific NES offsets, before the occurrence of a cell non-active period, which can be implemented in the UE of FIG. 1A;

FIG. 10 is a flow diagram of an example method for determining when a BS will start a cell non-active period, based on a broadcast notification from the BS, which can be implemented in the UE of FIG. 1A;

FIG. 11 is a flow diagram of an example method for determining when a BS will start a cell non-active period, based on a dedicated RRC message from the BS, which can be implemented in the UE of FIG. 1A;

FIG. 12 is a flow diagram of an example method for determining when a BS will start a cell non-active period, based on a periodic cell DTX/DRX configuration transmitted by the BS, which can be implemented in the UE of FIG. 1A;

FIG. 13 is a flow diagram of an example method for evaluating the cell reselection criteria using the remaining active time of the cells, before the occurrence of a cell non-active period, which can be implemented in the UE of FIG. 1A;

FIG. 14 is a flow diagram of an example method for determining whether the UE should trigger neighbor cell measurements before the serving cell enters a cell non-active period, which can be implemented in the UE of FIG. 1A;

FIG. 15 is a flow diagram of an example method for informing the UE of the neighbor cell(s) operating in the cell DTX/DRX mode and a common NES offset associated with these cells, which can be implemented in the BS of FIG. 1A;

FIG. 16 is a flow diagram of an example method for informing the UE of the neighbor cell(s) operating in the cell DTX/DRX and the cell-specific NES offsets associated to these cells, which can be implemented in the BS of FIG. 1A;

FIG. 17 is a flow diagram of an example method for informing the UE of when a neighbor cell will start its cell non-active period, which can be implemented in the BS of FIG. 1A; and

FIG. 18 is a flow diagram of an example method for cell reselection, which can be implemented in the UE of FIG. 1A.

### DETAILED DESCRIPTION OF THE DRAWINGS

As discussed in more detail below, a user equipment (UE) and/or a network node of a radio access network (RAN) can use the techniques of this disclosure for managing data communication and transitioning a UE between states of a protocol for controlling radio resources between the UE and the RAN.

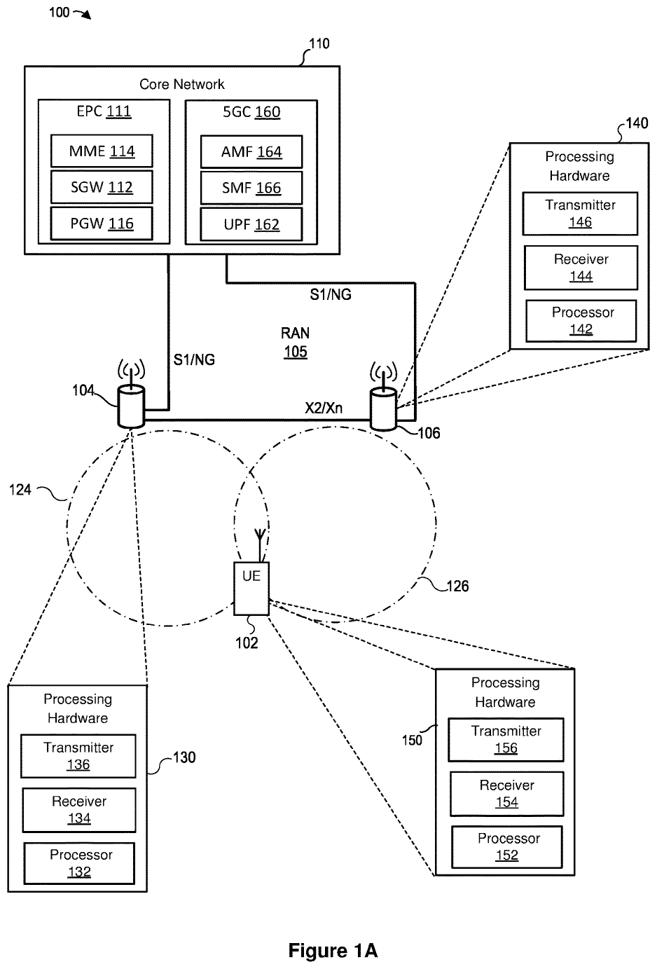

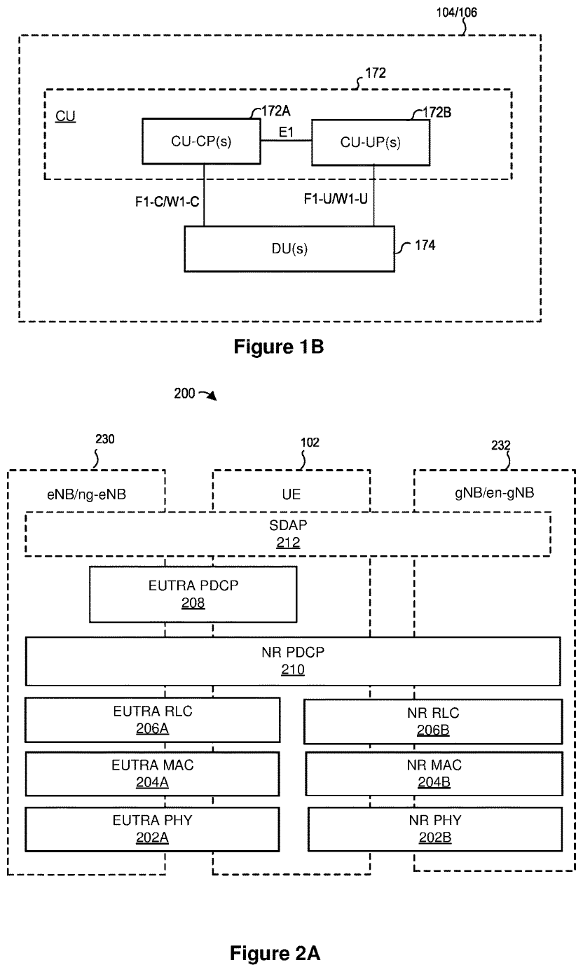

Referring first to FIG. 1A, an example wireless communication system 100 includes a UE 102, a base station (BS) 104, a BS 106, and a core network (CN) 110. The BS 104 and 106 can operate in a RAN 105 connected to the CN 110. The CN 110 can be implemented as an evolved packet core (EPC) 111 or a fifth generation (5G) core (5GC) 160, for example. The CN 110 can also be implemented as a sixth generation (6G) core in another example.

The BS 104 covers a cell 124, and the BS 106 covers a cell 126. If the BS 104 is a gNB, the cell 124 is an NR cell. If the BS 104 is an ng-eNB or eNB, the cell 124 is an evolved universal terrestrial radio access (E-UTRA) cell. Similarly, if the BS 106 is a gNB, the cell 126 is an NR cell, and if the BS 106 is an ng-eNB or eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the BS 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage Packet Data Unit (PDU) sessions.

As illustrated in FIG. 1A, the BS 104 supports a cell 124, and the BS 106 supports a cell 126. The cells 124 and 126 can partially overlap, so that the UE 102 can select, reselect, or hand over from one of the cells 124 and 126 to the other. To directly exchange messages or information, the BS 104 and BS 106 can support an X2 or Xn interface. In general, the CN 110 can connect to any suitable number of base stations supporting NR cells and/or EUTRA cells.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol.

The BS 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a processor 132 to process data that the BS 104 will transmit in the downlink direction, or process data received by the BS 104 in the uplink direction. The processing hardware 130 can also include a transmitter 136 configured to transmit data in the downlink direction. The processing hardware further can include a receiver 134 configured to receive data in the uplink direction. The BS 106 can include generally similar components. In particular, components 140, 142, 144, and 146 of the BS 106 can be similar to the components 130, 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a processor 152 to process data that the UE 102 will transmit in the uplink direction, or process data received by UE 102 in the downlink direction. The processing hardware 150 can also include a transmitter 156 configured to transmit data in the downlink direction. The processing hardware further can include a receiver 154 configured to receive data in the uplink direction.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a Packet Data Convergence Protocol (PDCP) controller, a RRC controller and/or a RRC inactive controller. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an IAB-node, and the CU 172 operates as an IAB-donor. In some embodiments, the RAN 105 supports Non-Terrestrial Network (NTN) functionality.

In some implementations, the CU 172 can include a logical node CU-CP 172A that hosts the control plane part of the PDCP of the CU 172. The CU 172 can also include logical node(s) CU-UP 172B that hosts the user plane part of the PDCP and/or Service Data Adaptation Protocol (SDAP) of the CU 172. The CU-CP 172A can transmit control information (e.g., RRC messages or F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

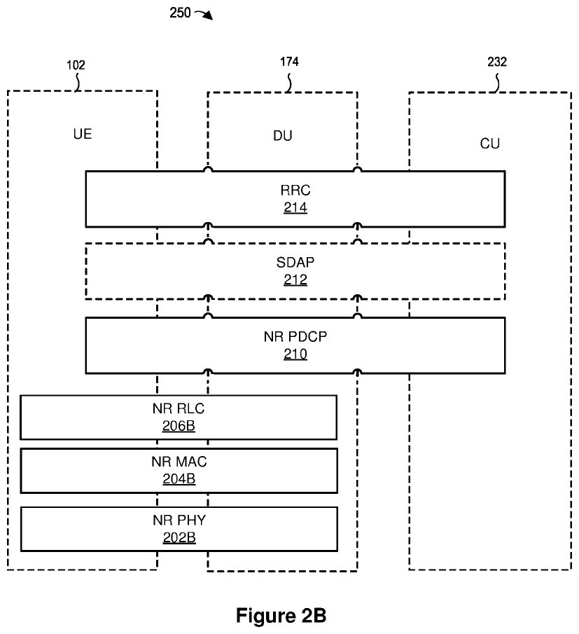

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

Generally speaking, cell DTX/DRX can apply at least to UEs currently operating in the connected state. For the cell DTX/DRX configuration, a BS can configure periodic cell DTX/DRX (i.e., active and non-active periods) via UE-specific RRC signaling per serving cell. Further, the BS can active or deactivate the cell DTX/DRX mode via dynamic L1/L2 signaling and UE-specific RRC signaling. There are generally four possibilities for the BS behavior during the non-active (i.e., off) period in the cell DTX/DRX mode: (i) the BS can turn off all transmission and reception for data traffic and reference signals during the cell DTX/DRX non-active periods; (ii) the BS can turn off its transmission/reception only for data traffic during the cell DTX/DRX non-active periods (i.e., the BS still transmits and/or receives reference signals); (iii) the BS can turn off its dynamic data transmission/reception during Cell DTX/DRX non-active periods (i.e., the BS still performs transmission and/or reception using the periodic resources, including SPS, CG-PUSCH, SR, RACH, and SRS); and (iv) the BS can only transmit reference signals (e.g., CSI-RS for measurement).

If the BS implements approach (i) or (iv) discussed above, then before the BS starts a cell non-active period, all the idle/inactive UEs that need to listen for the paging during the cell non-active period may have to leave the BS. These UEs would need to camp on another BS that does not affect the UE operation with respect to the paging monitoring. However, without knowing the exact time when the serving cell will start the cell non-active period, the UE may experience service interruption after the serving cell has started the cell non-active period, as the UE may not be able to trigger the neighbor cell measurement in time. Moreover, based on the current cell reselection criteria, an idle/inactive UE would evaluate/rank cells (including the serving and neighbor cells) without considering the impact of the network energy saving feature. As a result, even if the UE can trigger the neighbor cell measurement in time, the UE may remain in the serving cell or may reselect to another cell that still has the cell non-active periods overlapping with the paging occasions (POs) of the UE.

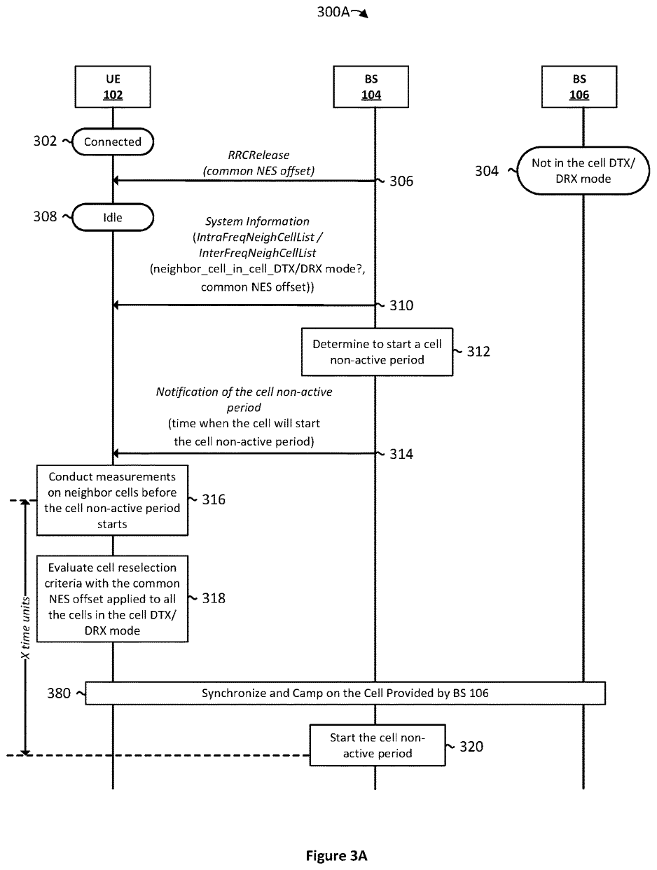

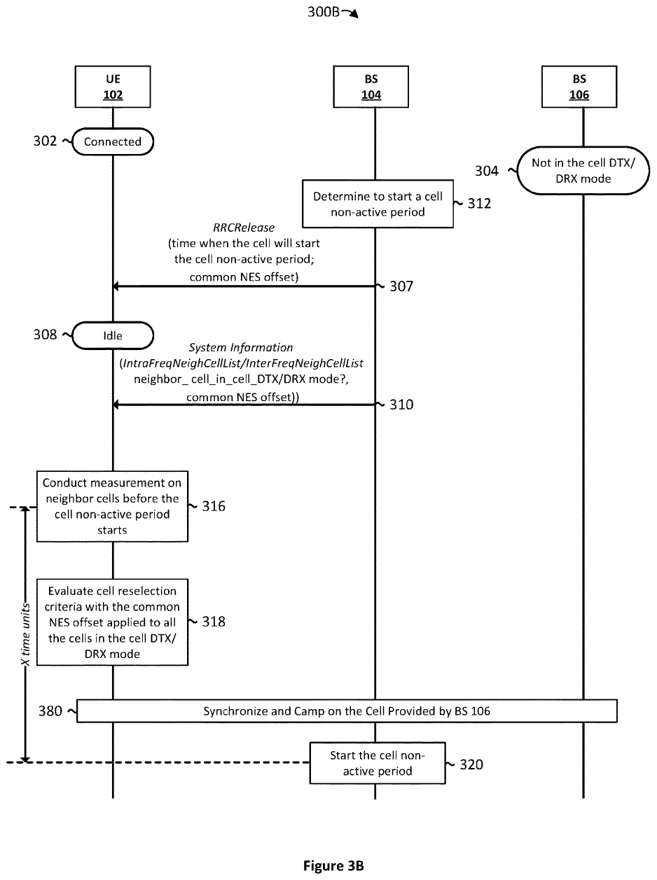

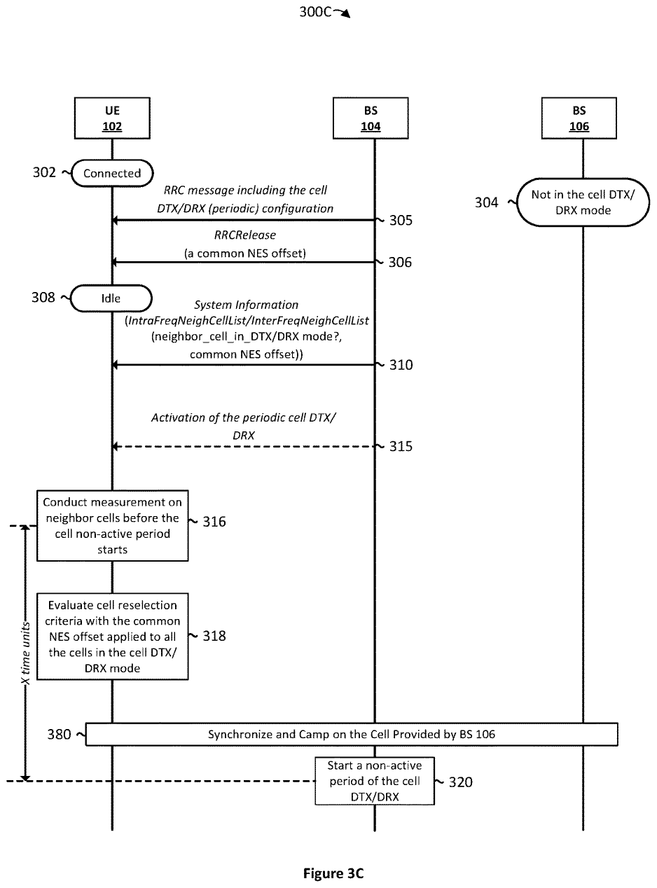

Next, several example scenarios in which a UE and/or a RAN perform the techniques of this disclosure for supporting network energy saving with enhanced cell reselection procedure are discussed with reference to FIGS. 3-6. Generally speaking, similar events in FIGS. 3-6 are labeled with the similar reference numbers, with differences discussed below where appropriate. For example, event 306 is similar to event 406, event 310 is similar to event 410 and 510, event 316 is similar to event 616, and event 318 is similar to event 418 and 518. To simplify the following description, the term “idle state” is used and can represent the RRC_IDLE or the RRC_INACTIVE state, and the term “connected state” is used and can represent the RRC_CONNECTED state.

FIG. 3A is a messaging diagram of an example scenario 300A of an example scenario in which a UE evaluates cell reselection criteria by applying a common NES offset to all the cells operating in the cell DTX/DRX mode, after receiving a notification of the occurrence of a cell non-active period via a common message.

In FIG. 3A, UE 102 initially establishes a connection with a cell managed by the BS 104 and then operates 302 in the connected state. Meanwhile, another cell managed by the BS 106 is available to the UE 102 as a neighbor cell, which is configured to operate 304 in a non-NES mode (i.e., the cell does not and will not operate 304 in the NES mode such cell DTX/DRX mode) for the entire duration of the example scenario 300. After operating 302 in the connected state for some time, the UE 102 receives 306 from the BS 104 an RRC Release message, which optionally includes a common NES offset. The UE 102 then transitions 308 to the idle state.

While operating in the idle state, the UE 102 receives from the BS 104 a system information indicating, in the IntraFreqNeighCellList/InterFreqNeighCellList IE, whether a neighbor cell is in the cell DTX/DRX mode. In one implementation, to indicate whether a neighbor cell is in the cell DTX/DRX mode, the BS 104 uses an IE/flag associated with that cell, where the presence of the IE/flag means the associated cell currently is, or will be in the future, in the cell DTX/DRX mode. Alternatively, the UE 102 receives from the BS 104 a system information including a list of the neighbor cells that are/will be operating in the cell DTX/DRX mode. The system information the BS 104 transmits 310 may also include a common NES offset, if the common NES offset is not included in the RRC Release message in the event 306.

At a later time, the BS 104 determines 312 to start a cell non-active period (a period where the BS 104 may turn off the transmission and/or reception for data and/or reference signal), in order to save energy. The BS 104 transmits/broadcasts 314 a notification to the UE 102 indicating when the cell will start the cell non-active period. The notification the BS 104 transmits 314 can be included in a system information, in a common RRC message (e.g., paging message), in a DL MAC CE, or in a DCI (e.g., short message in the paging DCI). In one implementation, the indication of when the cell will start the cell non-active period is an exact time instance described in a certain time format (e.g., Coordinated Universal Time (UTC)). In another implementation, the indication of when the cell will start the cell non-active period is a timer that starts running upon the UE 102 receiving the indication and expires at the beginning of the cell non-active period. Yet in another implementation, the indication of when the cell will start the cell non-active period includes a time instance and may include a duration, where the time instance is described in the format of system frame number (SFN) and subframe number and the duration is described in seconds, mini-seconds, system frames, or subframes. In one implementation, the notification the BS 104 transmits 314 may include a duration of the upcoming cell non-active period.

After the receiving 314 the notification of a cell non-active period, the UE 102 determines 316 to conduct the neighbor cell measurement before the cell non-active period starts. In one implementation, the UE 102 determines 316 to conduct the neighbor cell measurement X time units before the cell non-active period starts, where X can be an integer or a floating-point value, and the time units can be in minutes, seconds, mini-seconds, frames, subframes, or slots. Then, based on the measurement results the UE 102 obtains 316, the UE 102 evaluates 318 the cell reselection criteria by applying the common NES offset (obtained in the event 306 or 310) to all the cells operating in the cell DTX/DRX mode. For instance, while determining the cell ranking (the higher the better) for the serving cell (R_{S}) and for the neighbor cell (Rₙ), a UE generally uses the following formula:

$$\begin{matrix}{R}_{s} = {Q}_{meas , s} + {Q}_{hyst} - {Qoffset}_{temp} \\ {R}_{n} = {Q}_{meas , n} - Qoffset - {Qoffset}_{temp}\end{matrix}$$

(Formula 1), where:

TABLE 1

| | |
|---|---|
| Qₘₑₐₛ | RSRP measurement quantity used in cell |
| | reselections. |
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell as specified in |
| | 3GPP TS 38.331. |

Applying the common NES offset to the cells operating in the cell DTX/DRX mode, the formula becomes:

$$\begin{matrix}{R}_{s} = {Q}_{meas , s} + {Q}_{hyst} - {Qoffset}_{temp} + {Qoffset}_{NES} \\ {R}_{n} = {Q}_{meas , n} - Qoffset - {Qoffset}_{temp} + {Qoffset}_{NES}\end{matrix}$$

(Formula 2), where:

TABLE 2A

| | |
|---|---|
| Qₘₑₐₛ | RSRP measurement quantity used in cell reselections. |
| Qoffset | For intra-frequency: Equals to Qoffset_{s, n}, if Qoffset_{s, n} is |
| | valid, otherwise this equals to zero. |
| | For inter-frequency: Equals to Qoffset_{s, n} plus |
| | Qoffset_{frequency}, if Qoffset_{s, n} is valid, otherwise this equals |
| | to Qoffset_{frequency}. |
| Qoffsetₜₑₘₚ | Offset temporarily applied to a cell as specified in 3GPP |
| | TS 38.331. |
| Qoffset_{NES} | For cell operating in the cell DTX/DRX mode: Equals to |
| | the common NES offset signalled by the base station. |
| | For cell not operating in the cell DTX/DRX mode: Equals |
| | to zero. |

In one implementation, the common NES offset is always a negative value, which lowers the ranking of the cells operating in the cell DTX/DRX mode and hence makes these cells less preferable in the cell reselection procedure.

Based on the evaluation result the UE 102 obtains 318, the UE 102 determines to reselect the neighbor cell managed by the BS 106, and therefore starts 380 to synchronize and camp on the cell managed by the BS 106. Subsequently, the original serving cell (i.e., the cell managed by the BS 104) starts 320 the cell non-active period.

FIG. 3B is a messaging diagram of an scenario 300B in which a UE evaluates the cell reselection criteria by applying a common NES offset to all the cells operating in the cell DTX/DRX mode, after receiving a notification of the occurrence of a cell non-active period via a dedicated message.

The scenario 300B is similar to the scenario 300A of FIG. 3A, with the differences discussed below. In the scenario 300B, the BS 104 determines 312 to start a cell non-active period at an earlier time (relative to the scenario 300A), that is, before transmitting 307 the RRC Release message to the UE 102. Therefore, when BS 104 transmits 307 the RRC Release message to the UE 102, the BS 104 also indicates in the RRC Release message when the cell will start the cell non-active period. In one implementation, the indication of when the cell will start the cell non-active period is an exact time instance described in a certain time format (e.g., UTC). In another implementation, the indication of when the cell will start the cell non-active period is a timer that starts running upon the UE 102 receiving the indication and expires at the beginning of the cell non-active period. Yet in another implementation, the indication of when the cell will start the cell non-active period includes a time instance and may include a duration, where the time instance is described in the format of system frame number (SFN) and subframe number and the duration is described in seconds, mini-seconds, system frames, or subframes. In one implementation, the RRC Release message the BS 104 transmits 307 includes a duration of the upcoming cell non-active period.

FIG. 3C is a messaging diagram illustrating scenario 300C in which a UE evaluates cell reselection criteria by applying a common NES offset to all the cells operating in the cell DTX/DRX mode, before the occurrence of a periodic cell non-active period. The message diagram in FIG. 3C is similar to that in FIG. 3A, with the differences discussed below.

In the scenario 300C, the BS 104 starts a periodic cell non-active period, which occurs once per cell DTX/DRX cycle, instead of starting a cell non-active period dynamically. Thus, after the UE 102 connects to the BS 104, the BS 104 transmits or broadcasts 305 an RRC message indicating the cell DTX/DRX configuration (including the DTX/DRX cycle, the length of the cell non-active period, etc.) to the UE 102, where the RRC message can be a system information message, a Common Control Channel (CCCH) message, or a Dedicated Control Channel (DCCH) message.

In one implementation, the UE 102 considers the cell DTX/DRX mode to be deactivated upon receiving 305 the cell DTX/DRX configuration. In this case, the BS 104 has to transmit/broadcast 315 another activation notification to the UE 102 to activate the cell DTX/DRX mode configured to the UE 102 earlier, where the activation notification can be a system information, a dedicated/common RRC message, and DL MAC CE, or a DCI.

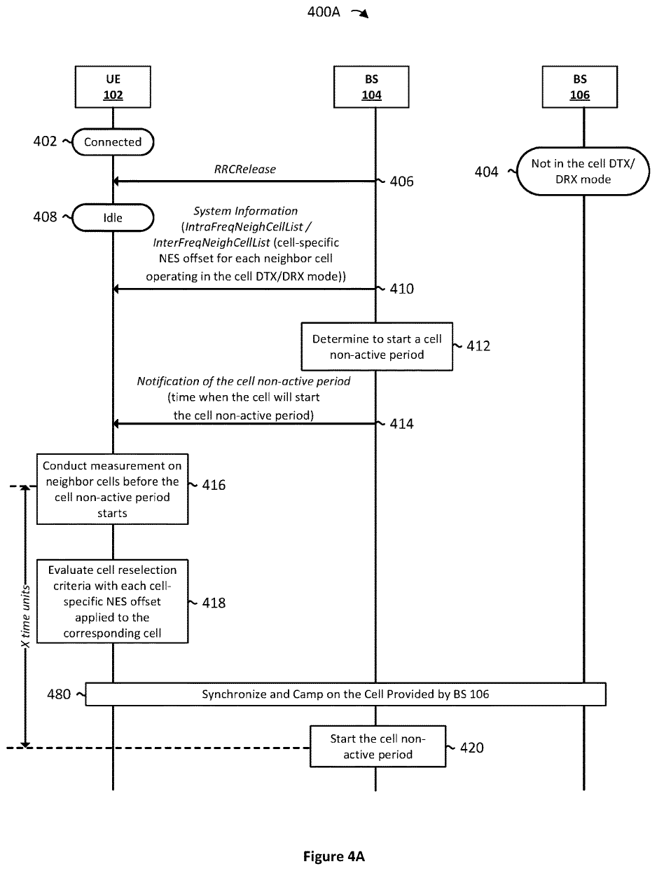

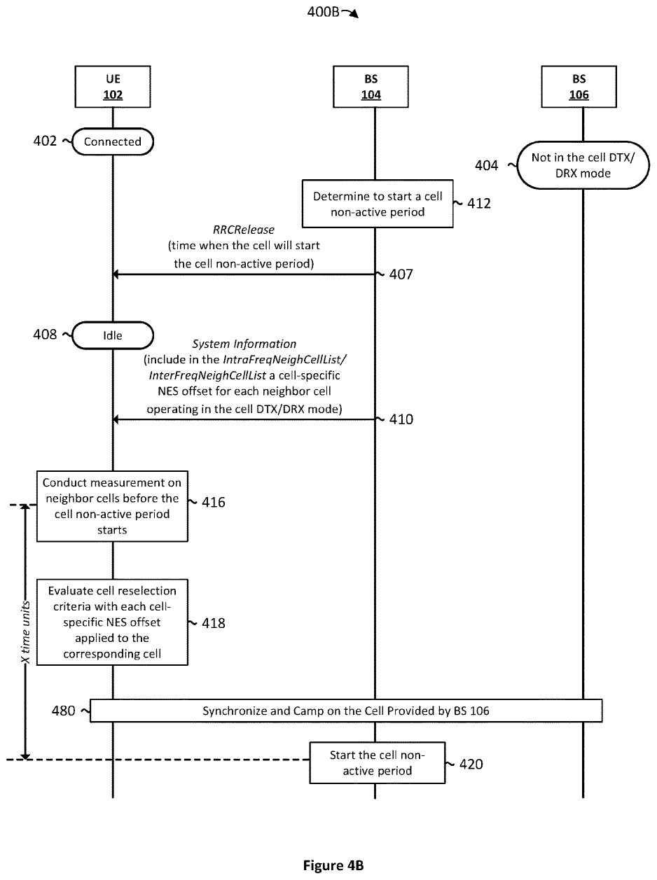

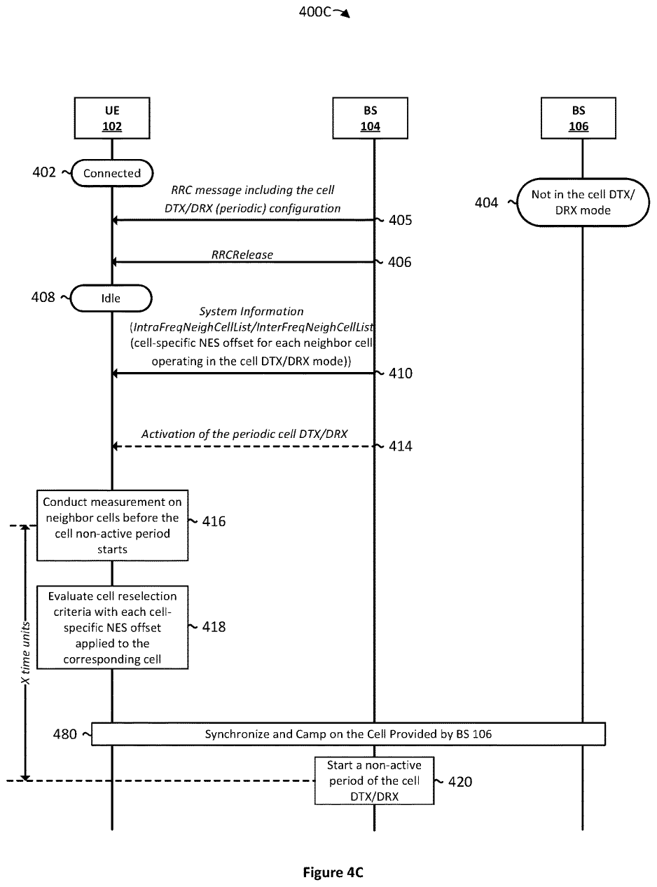

FIG. 4A is a messaging diagram illustrating scenario 400A in which a UE evaluates the cell reselection criteria by applying a cell-specific NES offset to the corresponding cell, after receiving a common message notifying the UE of a cell non-active period.

Th scenario 400A is generally similar to the scenario 300A of FIG. 3A, with the differences discussed below. In FIG. 4A, instead of sending a common NES offset to the UE 102 via the RRC Release message or via the system information, the BS 104 transmits 410 to the UE 102 a cell-specific NES offset for each neighbor cell operating in the cell DTX/DRX mode. In one implementation, the BS 104 transmits each cell-specific NES offset along with the cell identity of the corresponding cell via the system information (e.g., within the IntraFreqNeighCellList/InterFreqNeighCellList IE). In another implementation, the UE 102 receives 410 from the BS 104 a system information including a list of the neighbor cells that are/will be operating in the cell DTX/DRX mode and a cell-specific NES offset for each cell in the list.

After the receiving 414 the notification of a cell non-active period, the UE 102 determines 316 to conduct a neighbor cell measurement before the cell non-active period starts. Then, based on the measurement results the UE 102 obtains 416, the UE 102 evaluates 418 cell reselection criteria by applying individually the cell-specific NES offset (obtained in the event 410) to the corresponding cell operating in the cell DTX/DRX mode. As discussed above, while determining the cell ranking (the higher the better) for the serving cell (R_{S}) and for the neighbor cell (Rₙ), a UE generally uses Formula 1 and Table 1 discussed above. By applying the cell-specific NES offsets to the corresponding cells operating in the cell DTX/DRX mode, the formula becomes Formula 2 discussed above, but with Table 2B rather than Table 2A defining the parameters:

TABLE 2B

| | |
|---|---|
| Qₘₑₐₛ | RSRP measurement quantity used in cell reselections. |
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is valid, |
| | otherwise this equals to Qoffset_{frequency}. |
| Qoffsetₜₑₘₚ | Offset temporarily applied to a cell as specified in |
| | 3GPP TS 38.331. |
| Qoffset_{NES} | For cell operating in the cell DTX/DRX mode: Equals |
| | to the cell-specific NES offset signalled by the |
| | base station. For cell not operating in |
| | the cell DTX/DRX mode: Equals to zero |

In one implementation, the cell-specific NES offset is always a negative value, which lowers the ranking of the cells operating in the cell DTX/DRX mode and thus makes these cells less preferable in the cell reselection procedure.

FIG. 4B is a messaging diagram of an example scenario 400B, in which a UE evaluates the cell reselection criteria by applying a cell-specific NES offset to the corresponding cell, after being notified by a dedicated message the occurrence of a cell non-active period. The message diagram in FIG. 4B is similar to that in FIG. 4A, with the differences discussed below.

In FIG. 4B, the BS 104 determines 412 to start a cell non-active period at an earlier time (relative to the scenario 400A) that is before sending the RRC Release message to the UE 102. Thus, when the BS 104 transmits 407 the RRC Release message to the UE 102, the BS 104 also indicates in the RRC Release message when the cell will start the cell non-active period. In one implementation, the indication of when the cell will start the cell non-active period is an exact time instance described in a certain time format (e.g., UTC). In another implementation, the indication of when the cell will start the cell non-active period is a timer that starts running upon UE receiving the indication and expires at the beginning of the cell non-active period. Yet in another implementation, the indication of when the cell will start the cell non-active period includes a time instance and may include a duration, where the time instance is described in the format of system frame number (SFN) and subframe number and the duration is described in seconds, mini-seconds, system frames, or subframes. In one implementation, the RRC Release message the BS 104 transmits 407 includes a duration of the upcoming cell non-active period.

FIG. 4C is a messaging diagram of an example scenario 400C in which a UE evaluates the cell reselection criteria by applying a cell-specific NES offset to the corresponding cell, before the occurrence of a periodical cell non-active period. The scenario 400C is generally similar to the scenario 400A, with the differences discussed below.

In the scenario 400C, the BS 104 starts a periodic cell non-active period, once per cell DTX/DRX cycle, instead of starting a cell non-active period dynamically. Thus, after the UE 102 connects to the BS 104, the BS 104 transmits or broadcasts 405 an RRC message indicating the cell DTX/DRX configuration (including the DTX/DRX cycle, the length of the cell non-active period, etc.) to the UE 102, where the RRC message can be a system information message, a CCCH message, or a DCCH message.

In one implementation, the UE 102 considers the cell DTX/DRX mode to be deactivated upon receiving 405 the cell DTX/DRX configuration. In this case, the BS 104 has to transmit/broadcast 414 another activation notification to the UE 102 to activate the cell DTX/DRX mode configured to the UE 102 earlier, where the activation notification can be a system information, a dedicated/common RRC message, and DL MAC CE, or a DCI.

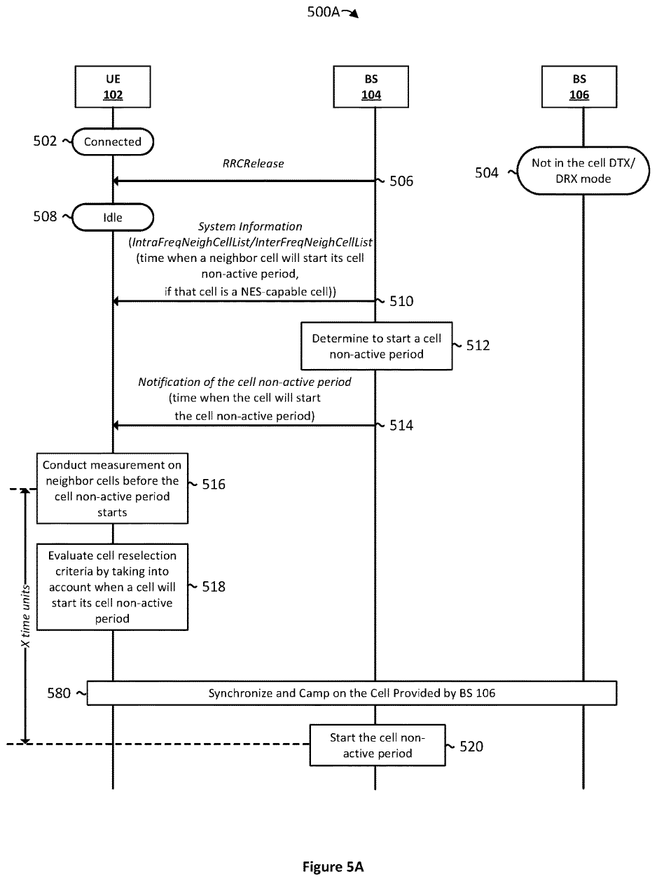

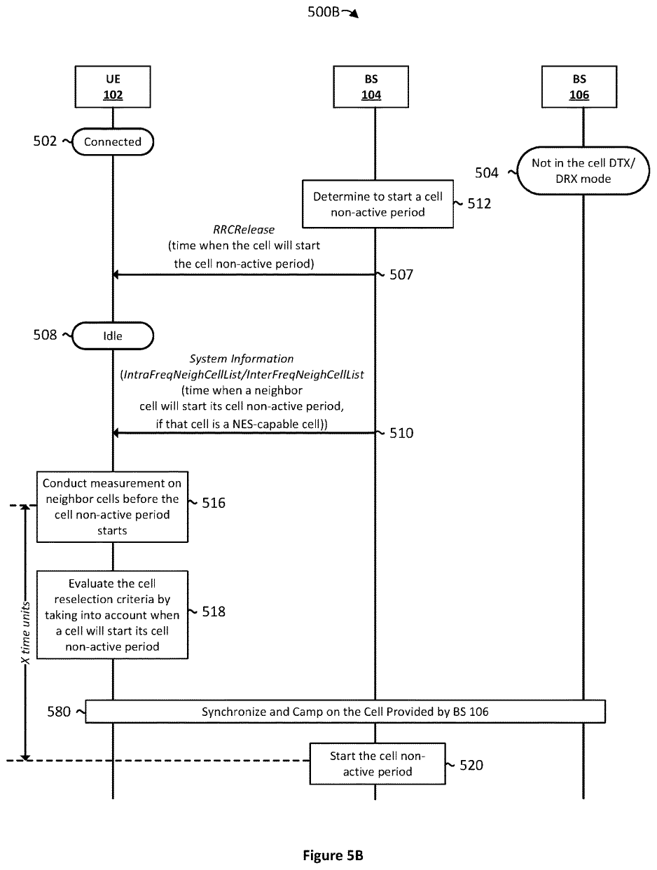

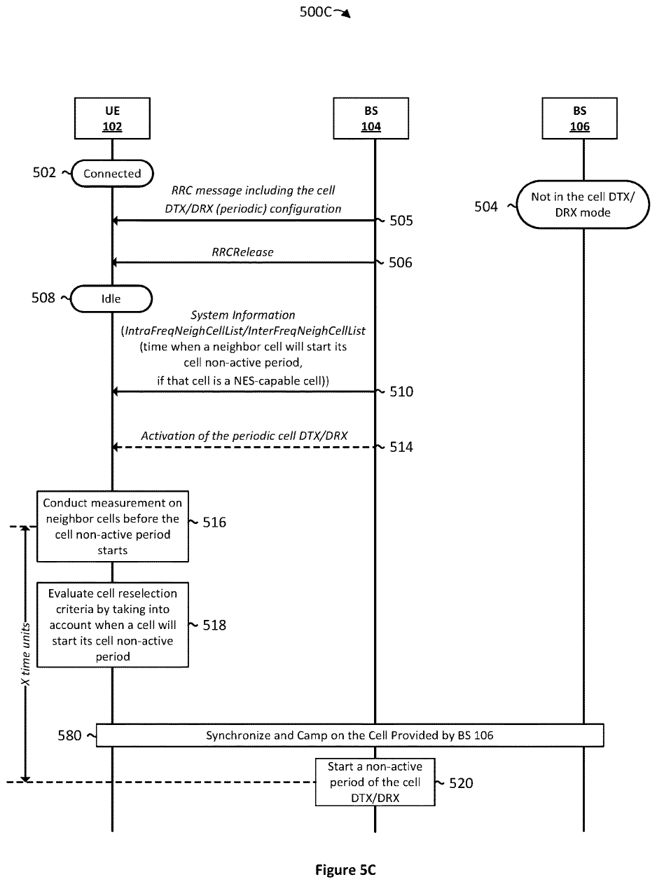

FIG. 5A is a messaging diagram of an example scenario 500A in which a UE evaluates the cell reselection criteria by considering when a cell will start its cell non-active period, after receiving a notification of the occurrence of a cell non-active period in a common message. The scenario of FIG. 5A is similar to that of FIG. 3A, with the differences discussed below.

In FIG. 5A, instead of sending a common NES offset to the UE 102 via the RRC Release message or via the system information, the BS 104 transmits 510 to the UE 102 the timing information regarding when a cell non-active period will start for each neighbor cell operating in the cell DTX/DRX mode. In one implementation, the BS 104 transmits the timing information along with the cell identity of the corresponding cell via the system information (e.g., within the IntraFreqNeighCellList/InterFreqNeighCellList IE). In another implementation, the UE 102 receives 510 from the BS 104 a system information message including a list of neighbor cells that are/will be operating in the cell DTX/DRX mode, and the timing information regarding when a cell non-active period will start for each cell in the list. In one implementation, the timing information is an exact time instance described in a certain time format (e.g., UTC). In another implementation, the timing information is a timer that starts running upon UE receiving the information and expires at the beginning of the cell non-active period. Yet in another implementation, the timing information includes a time instance and may include a duration, where the time instance is described in the format of system frame number (SFN) and subframe number and the duration is described in seconds, mini-seconds, system frames, or subframes.

After the receiving 514 the notification of a cell non-active period, the UE 102 determines 516 to conduct the neighbor cell measurement before the cell non-active period starts. After that, based on the measurement results obtained in the event 516, the UE 102 evaluates 518 the cell reselection criteria by considering when a cell will start its cell non-active period. As discussed above, when determining the cell ranking (the higher the better) for the serving cell (R_{S}) and for the neighbor cell (Rₙ), a UE generally uses Formula 1 and Table 1 discussed above.

To account for the time when a cell will start its cell non-active period, the formula becomes:

$$\begin{matrix}{R}_{s} = {Q}_{meas , s} + {Q}_{hyst} - {Qoffset}_{temp} - {Qoffset}_{NES} \\ {R}_{n} = {Q}_{meas , n} - Qoffset - {Qoffset}_{temp} - {Qoffset}_{NES}\end{matrix}$$

(Formula 3), where:

TABLE 3

| | |
|---|---|
| Qₘₑₐₛ | RSRP measurement quantity used in cell reselections. |
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is valid, |
| | otherwise this equals to Qoffset_{frequency}. |
| Qoffsetₜₑₘₚ | Offset temporarily applied to a cell as specified in |
| | 3GPP TS 38.331. |
| Qoffset_{NES} | For cell operating in the cell DTX/DRX mode: Equals |
| | to the time left (in minutes/hours) until the arrival |
| | of the next cell non-active period. |
| | For cell not operating in the cell DTX/DRX mode: |
| | Equals to zero. |

FIG. 5B is a messaging diagram of an example scenario 500B in which a UE evaluates the cell reselection criteria by considering when a cell will start its cell non-active period, after receiving a notification of the occurrence of a cell non-active period via a dedicated message. The scenario 500B is generally similar to the scenario 500A, with the differences discussed below.

In the scenario 500A, the BS 104 determines 512 to start a cell non-active period at an earlier time (relative to the scenario 500A), that is before transmitting 507 the RRC Release message to the UE 102. Therefore, when BS 104 transmits 507 the RRC Release message to the UE 102, the BS 104 also indicates in the RRC Release message when the cell will start the cell non-active period. In one implementation, the indication of when the cell will start the cell non-active period is an exact time instance described in a certain time format (e.g., UTC). In another implementation, the indication of when the cell will start the cell non-active period is a timer that starts running upon UE receiving the indication and expires at the beginning of the cell non-active period. Yet in another implementation, the indication of when the cell will start the cell non-active period includes a time instance and may include a duration, where the time instance is described in the format of system frame number (SFN) and subframe number and the duration is described in seconds, mini-seconds, system frames, or subframes. In one implementation, the RRC Release message transmitted in the event 507 may include a duration of the upcoming cell non-active period.

FIG. 5C is a messaging diagram of an example example scenario 500C in which a UE evaluates the cell reselection criteria by considering when a cell will start its cell non-active period, before the occurrence of a periodic cell non-active period. The message diagram in FIG. 5C is similar to that in FIG. 5A, with the differences discussed below.

In the scenario 500C, the BS 104 periodically starts a cell non-active period, once per cell DTX/DRX cycle, instead of starting a cell non-active period dynamically. Thus, after the UE 102 connects to the BS 104, the BS 104 transmits or broadcasts 505 a RRC message indicating the cell DTX/DRX configuration (including the DTX/DRX cycle, the length of the cell non-active period, etc.) to the UE 102, where the RRC message can be a system information message, a CCCH message, or a DCCH message.

In one implementation, the UE 102 considers the cell DTX/DRX mode to be deactivated upon receiving 505 the cell DTX/DRX configuration. In this case, the BS 104 has to transmit/broadcast 514 another activation notification to the UE 102 to activate the cell DTX/DRX mode configured to the UE 102 earlier, where the activation notification can be a system information, a dedicated/common RRC message, and DL MAC CE, or a DCI.

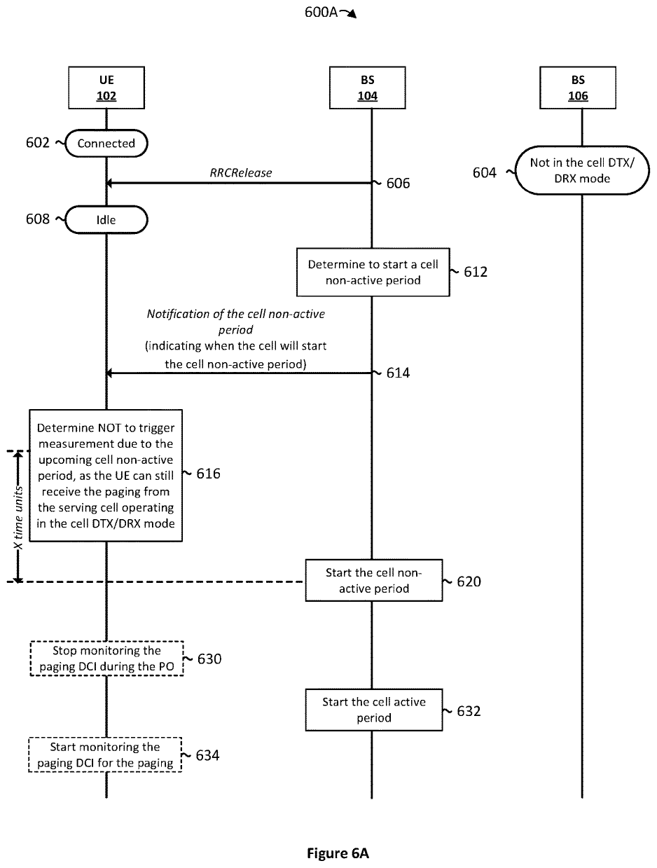

FIG. 6A is a messaging diagram of example scenario 600A in which a UE determines whether to conduct the neighbor cell measurement, after receiving a notification of the occurrence of a cell non-active period via a common message. The message diagram in FIG. 6A is similar to that in FIG. 3A, with the differences discussed below.

In the scenario 600A, the UE 102 receives neither the common NES offset nor the information regarding which neighbor cell(s) are/is/will be operating in the cell DTX/DRX mode.

After the receiving 614 the notification of a cell non-active period, the UE 102 determines whether to conduct the neighbor cell measurement before the cell non-active period starts, based on whether the UE 102 can monitor the paging DCI, even after the serving cell has entered the cell DTX/DRX mode. In this example, the UE 102 determines 616 to not trigger measurement due to the upcoming cell non-active period, either because the paging occasions (POs) of the UE do not overlap with the cell non-active periods, or because the UE 102 and BS 104 can adjust/shift/extend the POs of the UE, so that the UE 102 can monitor the paging only during the cell active periods.

The BS 104 then starts 620 a cell non-active period, and then the UE 102 may stop 630 monitoring the paging DCI during the PO, if the PO falls within the cell non-active period. At a later time, the BS 104 resumes 632 the cell active period, and then the UE 102 may start 634 monitoring the paging DCI in the original POs and/or in the shifted/adjusted POs.

FIG. 6B is a messaging diagram of an example scenario 600B in which a UE determines whether to conduct the neighbor cell measurement, before the occurrence of a periodic cell non-active period. The scenario 600B is generally similar to the scenario 600A, with the differences discussed below.

In the scenario 600B, the BS 104 periodically starts a cell non-active period, once per cell DTX/DRX cycle, instead of starting a cell non-active period dynamically. Thus, after the UE 102 connects to the BS 104, the BS 104 transmits or broadcasts 605 an RRC message indicating the cell DTX/DRX configuration (including the DTX/DRX cycle, the length of the cell non-active period, etc.) to the UE 102, where the RRC message can be a system information message, a CCCH message, or a DCCH message.

In one implementation, the UE 102 considers the cell DTX/DRX mode to be deactivated upon receiving 605 the cell DTX/DRX configuration. In this case, the BS 104 has to transmit/broadcast 614 another activation notification to the UE 102 to activate the cell DTX/DRX mode configured to the UE 102 earlier, where the activation notification can be a system information, a dedicated/common RRC message, and DL MAC CE, or a DCI.

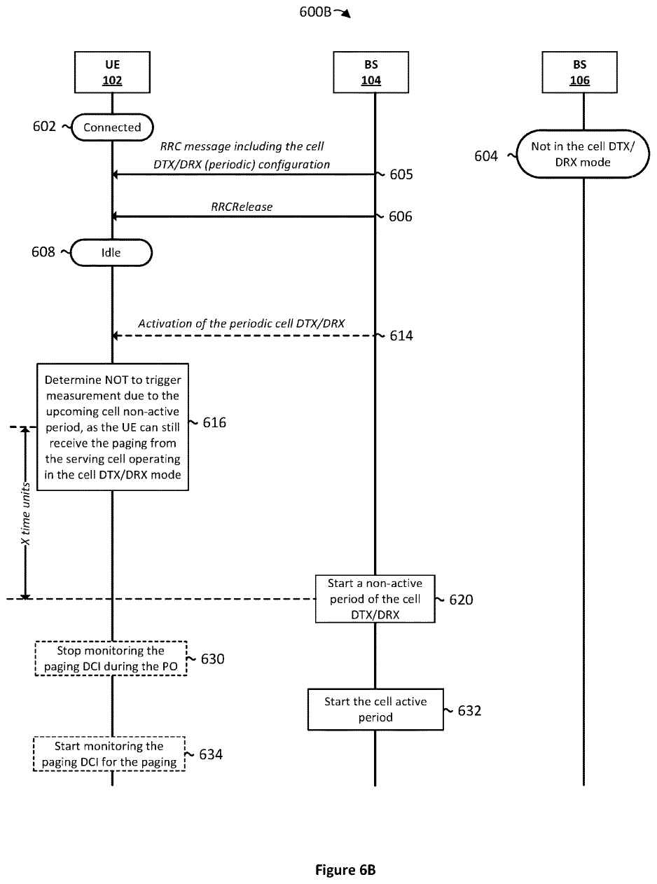

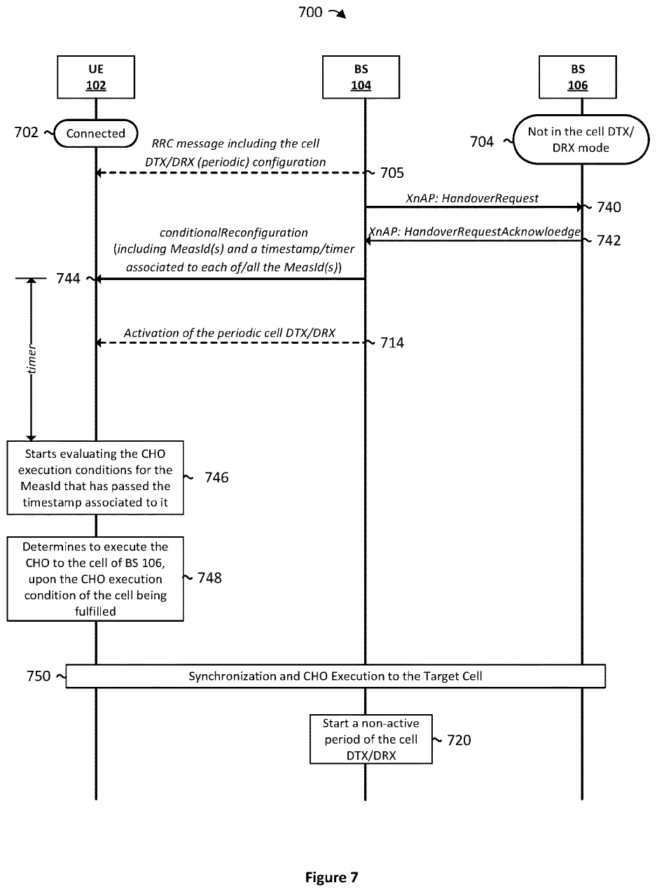

FIG. 7 is a messaging diagram of an example scenario 700, in which a UE in the connected state triggers the candidate cell evaluation for the conditional handover (CHO) execution, based on the timing information provided in the CHO configuration. In the scenario 700, the UE 102 initially establishes a connection with a cell managed by the BS 104, and then stays 702 in the connected state. Meanwhile, another cell managed by BS 106 is available to the UE 102 as a neighbor cell, which does NOT and will NOT operate 704 in the NES mode (e.g., cell DTX/DRX mode) for the entire duration of this example.

In the scenario 700, the BS 104 determines to periodically start a cell non-active period, once per cell DTX/DRX cycle. Thus, after the UE 102 has connected to the BS 104, the BS 104 transmits 705 a RRC message indicating the cell DTX/DRX configuration (including the DTX/DRX cycle, the length of the cell non-active period, etc.) to the UE 102, where the RRC message can be a system information message, a CCCH message, or a DCCH message.

The BS 104 then proactively prepares for UE 102 the CHO candidates by transmitting 740 Handover Request messages to these candidates (which include the BS 106), for the preparation of a potential cell non-active period in the future. In response to the Handover Request message, the BS 106 transmits 742 a Handover Request Acknowledge message to the BS 104, to accept the handover request. Upon receiving the Handover Request Acknowledge message, the BS 104 transmits 744 a conditionalReconfiguration IE (via the RRCReconfiguration message) including one or more than one candidate cell configurations to the UE 102, where at least one of the candidate cell configurations contains a CHO execution condition (i.e., MeasId) and a timestamp associated to the CHO execution condition. In one implementation, the timestamp is an exact time instance described in a certain time format (e.g., UTC). In another implementation, the timestamp contains a timer that starts running upon the UE 102 receiving the timestamp and expires at the time intended by the timestamp. Yet in another implementation, the timestamp includes a time instance and may include a duration, where the time instance is described in the format of a system frame number (SFN) and a subframe number and the duration is described in seconds, mini-seconds, system frames, or subframes.

After receiving 744 a conditionalReconfiguration IE including at least one CHO execution condition (i.e., MeasId) associated with a timestamp, the UE 102 determines regularly if the current time has pass the timestamp associated to a CHO execution condition. At event 746, since the current time has passed the timestamp associated to the CHO execution condition for the cell managed by the BS 106, the UE 102 starts evaluating the CHO execution condition for the cell managed by the BS 106. Eventually, the UE 102 determines 748 to execute the CHO to the cell of BS 106, upon the CHO execution condition of the cell being fulfilled. After that, the UE 102 synchronizes and executes the CHO 750 with the cell of the BS 106.

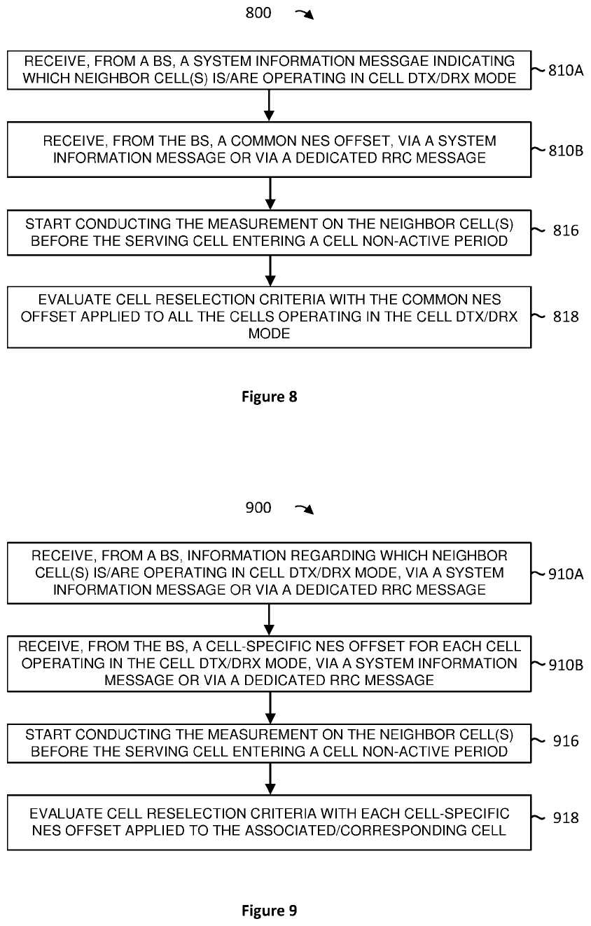

FIG. 8 is a flow diagram of an example method 800 that can be implemented by a UE (e.g., UE 102 in this disclosure) in the idle state, for evaluating the cell reselection criteria using a common NES offset, before the occurrence of a cell non-active period. Initially, at block 810A, the UE receives, from a BS, a system information indicating which neighbor cell(s) is/are operating in cell DTX/DRX mode. In one implementation, the indication of whether a neighbor cell is in the cell DTX/DRX mode or not is transmitted within the IntraFreqNeighCellList/InterFreqNeighCellList IE and is associated to a cell, where the presence of the indication means the associated cell is/will be in the cell DTX/DRX mode. In another implementation, the indication of whether a neighbor cell is in the cell DTX/DRX mode or not is determined based on whether that cell is included in a list of the NES/DTX/DRX cells.

The UE also receives, from the BS, at block 810B, a common NES offset via a system information message or via a dedicated RRC message. The sequence of block 810A and 810B can be changed in this flow diagram. At block 816, the UE starts conducting the measurement on the neighbor cell(s) before the serving cell entering a cell non-active period. In another implementation, the UE at block 816 starts conducting the measurement on the neighbor cell(s) even if the serving cell is not entering/will not enter a cell non-active period.

Based on the measurement results obtained at block 816, the UE evaluates, at block 818, the cell reselection criteria with the common NES offset applied to all the cells operating in the cell DTX/DRX mode.

FIG. 9 is a flow diagram of an example method 900 that can be implemented by a UE (e.g., UE 102 in this disclosure) in the idle state, for evaluating the cell reselection criteria using the cell-specific NES offsets, before the occurrence of a cell non-active period. At block 910A, the UE receives, from a BS, information regarding which neighbor cell(s) is/are operating in cell DTX/DRX mode, via a system information message or via a dedicated RRC message. In one implementation, the information regarding which neighbor cell(s) is/are operating in cell DTX/DRX mode is delivered through a ‘NES_mode’ or a ‘DTX/DRX_mode’ IE/flag associated with a cell identity in an existing cell list. In another implementation, the information regarding which neighbor cell(s) is/are operating in cell DTX/DRX mode is delivered through a list of the NES/DTX/DRX cells.

At block 910B, the UE also receives, from the BS, a cell-specific NES offset for each cell operating in the cell DTX/DRX mode, via a system information or via a dedicated RRC message. At block 916, the UE starts conducting the measurement on the neighbor cell(s) before the serving cell entering a cell non-active period. In another implementation, at block 916 the UE starts conducting the measurement on the neighbor cell(s) even if the serving cell is not entering/will not enter a cell non-active period.

Based on the measurement results obtained at block 916, the UE evaluates, at block 918, the cell reselection criteria with each cell-specific NES offset applied to the associated/corresponding cell.

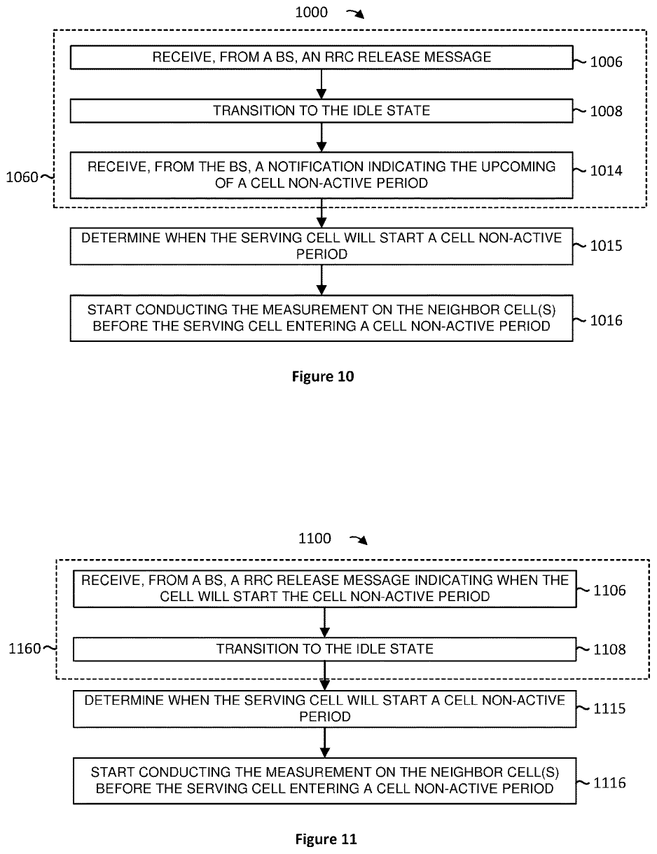

FIG. 10 is a flow diagram of an example method 1000 that can be implemented by a UE (e.g., UE 102 in this disclosure) in the idle state, for determining when a BS will start a cell non-active period, based on a broadcast notification transmitted by the BS. At block 1006, the UE receives, from a BS, an RRC Release message. At block 1008, in response to the RRC Release message, the UE transitions to the idle state.

At block 1014, the UE receives, from the BS, a notification indicating the upcoming of a cell non-active period. In one implementation, the notification received by the UE at block 1014 is an exact time instance described in a certain time format (e.g., UTC). In another implementation, the notification received by the UE at block 1014 is a timer that starts running upon the UE receiving the notification and expires at the beginning of the cell non-active period. Yet in another implementation, the notification received by the UE at block 1014 includes a time instance and may include a duration, where the time instance is described in the format of system frame number (SFN) and subframe number and the duration is described in seconds, mini-seconds, system frames, or subframes. In one implementation, the notification received by the UE at block 1014 may include a duration of the upcoming cell non-active period. The blocks 1006, 1008, and 1014 are collectively referred to in FIG. 10 as the procedure 1060 for “receiving the broadcast notification of a cell non-active period.”

The flow then proceeds to block 1015, where the UE determines when the serving cell will start a cell non-active period, based on the information received at block 1014. After that, the UE starts, at block 1016, conducting the measurement on the neighbor cell(s) before the serving cell entering a cell non-active period.

FIG. 11 is a flow diagram of an example method 1100 that can be implemented by a UE (e.g., UE 102 in this disclosure) in the idle state, for determining when a BS will start a cell non-active period, based on a dedicated RRC message transmitted by the BS. At block 1106, the UE receives, from a BS, an RRC Release message indicating when the cell will start the cell non-active period.

At block 1108, in response to the RRC Release message, the UE transitions to the idle state. Alternatively, the indication of when the cell will start the cell non-active period is received by the UE at block 1106 in a dedicated RRC message other than the RRC Release message. In one implementation, the indication of when the cell will start the cell non-active period is an exact time instance described in a certain time format (e.g., UTC). In another implementation, the indication of when the cell will start the cell non-active period is a timer that starts running upon the UE receiving the notification and expires at the beginning of the cell non-active period. Yet in another implementation, the indication of when the cell will start the cell non-active period includes a time instance and may include a duration, where the time instance is described in the format of system frame number (SFN) and subframe number and the duration is described in seconds, mini-seconds, system frames, or subframes. In one implementation, the indication of when the cell will start the cell non-active period may include a duration of the upcoming cell non-active period. The block 1106 and 1108 are collectively referred to in FIG. 11 as the procedure 1160 for “receiving the dedicated notification of a cell non-active period”.

The flow then proceeds to block 1115, where the UE determines when the serving cell will start a cell non-active period, based on the information received at block 1106. At block 1116, the UE starts conducting the measurement on the neighbor cell(s) before the serving cell entering a cell non-active period.

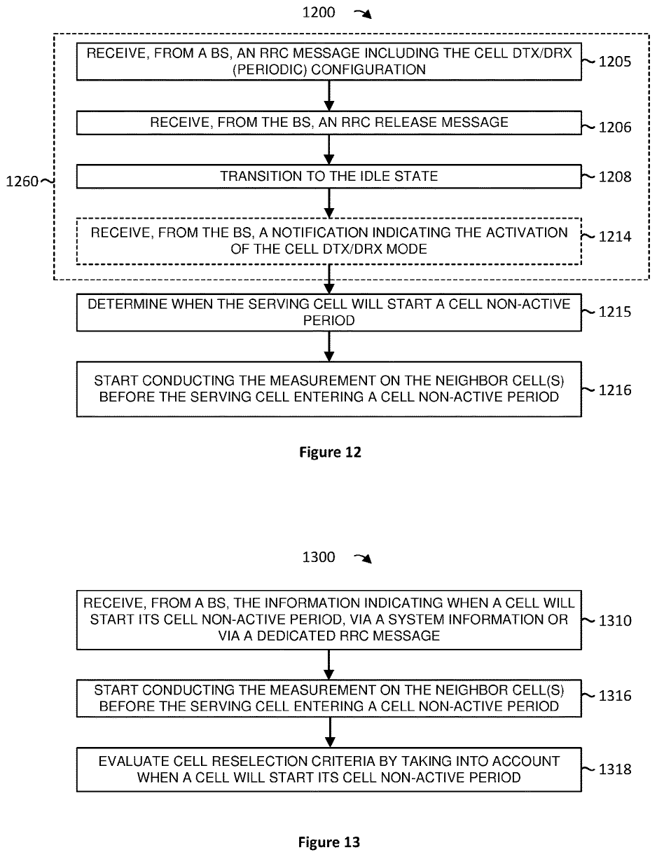

FIG. 12 is a flow diagram of an example method 1200 that can be implemented by a UE (e.g., UE 102 in this disclosure) in the idle state, for determining when a BS will start a cell non-active period, based on a periodical cell DTX/DRX configuration transmitted by the BS. At block 1206, the UE receives, from a BS, a RRC message (e.g., a DCCH or a CCCH message) including the cell DTX/DRX (periodical) configuration, where the cell DTX/DRX configuration may include a DTX/DRX cycle length and a length of the cell non-active period. The UE then receives, at block 1206, from the BS, a RRC Release message. In response to the RRC Release message, the UE transitions, at block 1208, to the idle state.

In one implementation, the UE 102 considers the cell DTX/DRX mode to be deactivated upon receiving the cell DTX/DRX configuration at block 1205. In this case, the UE will receive, at block 1214, another activation notification for activating the cell DTX/DRX mode configured to the UE earlier, where the activation notification can be a system information, a dedicated/common RRC message, and DL MAC CE, or a DCI. The blocks 1205, 1206, 1208, and 1214 are collectively referred to in FIG. 12 as the procedure 1260 for “receiving the periodical cell DTX/DRX configuration”.

The flow then proceeds to block 1215, where the UE determines when the serving cell will start a cell non-active period, based on the information received at block 1205 and optionally at block 1214. At block 1216, the UE starts conducting the measurement on the neighbor cell(s) before the serving cell entering a cell non-active period.

FIG. 13 is a flow diagram of an example method 1300 that can be implemented by a UE (e.g., UE 102 in this disclosure) in the idle state, for evaluating the cell reselection criteria using the remaining active time of the cells, before the occurrence of a cell non-active period. At block 1310, the UE receives, from a BS, the information indicating when a cell will start its cell non-active period, via a system information message or via a dedicated RRC message. In one implementation, the information indicating when a cell will start its cell non-active period is an exact time instance described in a certain time format (e.g., UTC). In another implementation, the information indicating when a cell will start its cell non-active period is a timer that starts running upon UE receiving the information and expires at the beginning of the cell non-active period. Yet in another implementation, the information indicating when a cell will start its cell non-active period includes a time instance and may include a duration, where the time instance is described in the format of system frame number (SFN) and subframe number and the duration is described in seconds, mini-seconds, system frames, or subframes.

At block 1316, the UE starts conducting the measurement on the neighbor cell(s) before the serving cell entering a cell non-active period. In another implementation, the UE starts, at block 1316, conducting the measurement on the neighbor cell(s) even if the serving cell is not entering/will not enter a cell non-active period. Based on the measurement results obtained at block 1316, the UE evaluates, at block 1318, the cell reselection criteria by considering when a cell will start its cell non-active period.

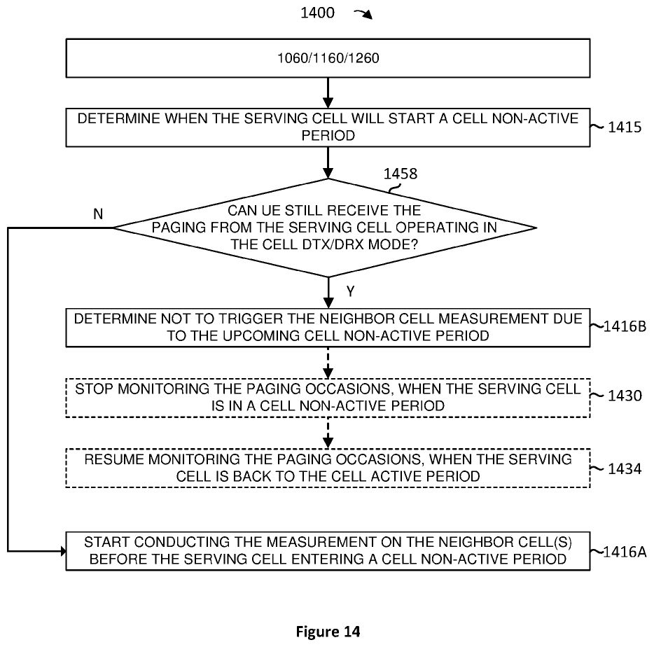

FIG. 14 is a flow diagram of an example method 1400 that can be implemented by a UE (e.g., UE 102 in this disclosure) in the idle state, for determining whether the UE shall trigger the neighbor cell measurement before the serving cell enters a cell non-active period. At block 1415, the UE determines when the serving cell will start a cell non-active period, based on the information obtained from the procedure 1060, 1160, or 1260.

The flow then proceeds to the decision block 1458, where the UE determines if the UE can still receive the paging from the serving cell operating in the cell DTX/DRX mode. If the determination at the decision block 1458 is negative, the flow proceeds to the block 1416A, where the UE shall start conducting the measurement on the neighbor cell(s) before the serving cell entering a cell non-active period.

On the other hand, if the determination at the decision block 1458 is positive, the flow proceeds to the block 1416B, where the UE determines not to trigger the neighbor cell measurement due to the upcoming cell non-active period. After the serving cell has started/entered the cell non-active period, the UE may stop, at block 1430, monitoring the paging occasions. If the UE has chosen to stop monitoring the paging occasions, the UE may resume, at block 1434, monitoring the paging occasions after the serving cell is back to the cell active period.

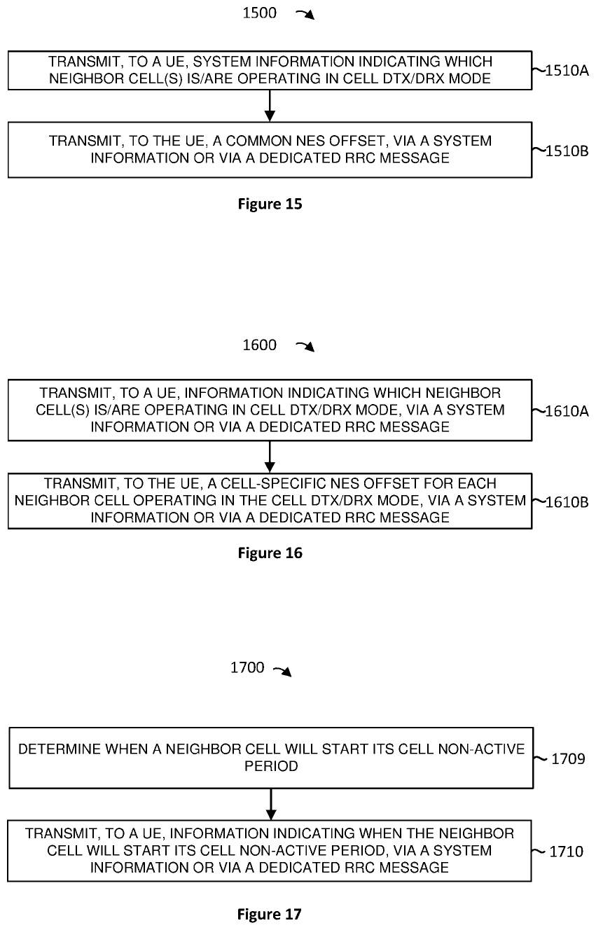

FIG. 15 is a flow diagram of an example method 1500 that can be implemented by a BS (e.g., BS 104 in this disclosure), for informing the UE of the neighbor cell(s) operating in the cell DTX/DRX mode and a common NES offset associated to these cells. Initially, at block 1510A, the BS transmits, to a UE, a system information indicating which neighbor cell(s) is/are operating in cell DTX/DRX mode. In one implementation, the indication of whether a neighbor cell is in the cell DTX/DRX mode or not is transmitted within the IntraFreqNeighCellList/InterFreqNeighCellList IE and is associated to a cell, where the presence of the indication means the associated cell is/will be in the cell DTX/DRX mode. In another implementation, the indication of whether a neighbor cell is in the cell DTX/DRX mode or not is determined based on whether that cell is included in a list of the NES/DTX/DRX cells.

The BS also transmits, at block 1510B, a common NES offset via a system information message or via a dedicated RRC message, where the common NES offset is to be applied to those cells operating in the cell DTX/DRX mode. The sequence of block 1510A and 1510B can be changed in this flow diagram.

FIG. 16 is a flow diagram of an example method 1600 that can be implemented by a BS (e.g., BS 104 in this disclosure), for informing the UE of the neighbor cell(s) operating in the cell DTX/DRX and the cell-specific NES offsets associated to these cells. Initially, at block 1610A, the BS transmits, to a UE, a system information or a dedicated RRC message indicating which neighbor cell(s) is/are operating in cell DTX/DRX mode. In one implementation, the indication of whether a neighbor cell is operating in the cell DTX/DRX mode or not is transmitted within the IntraFreqNeighCellList/InterFreqNeighCellList IE and is associated to a cell, where the presence of the indication means the associated cell is/will be in the cell DTX/DRX mode. In another implementation, the indication of whether a neighbor cell is in the cell DTX/DRX mode or not is determined based on whether that cell is included in a list of the NES/DTX/DRX cells.

At block 1610B, the BS transmits, to the UE, a cell-specific NES offset for each neighbor cell operating in the cell DTX/DRX mode, via a system information message or via a dedicated RRC message.

FIG. 17 is a flow diagram of an example method 1700 that can be implemented by a BS (e.g., BS 104 in this disclosure), for informing the UE of when a neighbor cell will start its cell non-active period. At block 1709, the BS determines when a neighbor cell will start its cell non-active period. Next, at block 1710, the BS transmits a system information message or a dedicated RRC message including the information on when a neighbor cell will start its cell non-active period. In one implementation, the information indicating when a cell will start its cell non-active period is an exact time instance described in a certain time format (e.g., UTC). In another implementation, the information on when a cell will start its cell non-active period is a timer that starts running upon UE receiving the information and expires at the beginning of the cell non-active period. Yet in another implementation, the information on when a cell will start its cell non-active period includes a time instance and may include a duration, where the time instance is described in the format of system frame number (SFN) and subframe number and the duration is described in seconds, mini-seconds, system frames, or subframes.

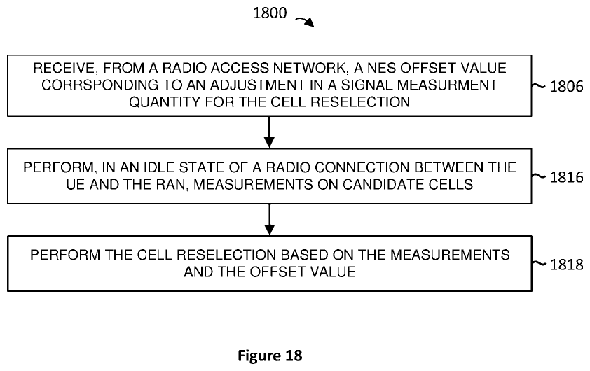

Finally, FIG. 18 illustrates an example method 800, which a suitable UE (e.g., the UE 102) can implement to perform cell reselection. At block 1806, the UE receives, from the RAN, an NES offset value corresponding to an adjustment in a signal measurement quantity for the cell reselection (e.g., events 306, 307, 410, 810B, 910B). At block 816, the UE operates in an idle state of a radio connection between the UE and the RAN (e.g., RRC_IDLE) and conducts measurements on candidate cells, such as the neighbor cells (e.g., events 316, 416, 516, 1016, 1116, 1216, 1316). At block 1818, the UE performs the cell reselection based on the measurements and the offset value (e.g., events 318, 418, 518, 818, 918, 1318).

The following list of examples reflects a variety of the embodiments explicitly contemplated by the present disclosure.

Example 1. A method for cell reselection, the method implemented in a user equipment (UE) and comprising: receiving, from a radio access network (RAN), a network energy saving (NES) offset value corresponding to an adjustment in a signal measurement quantity for the cell reselection; performing, in an idle state of a radio connection between the UE and the RAN, measurements on a plurality of candidate cells; performing the cell reselection based on the measurements and the offset value.

Example 2. The method of example 1, wherein the performing of the cell reselection includes: ranking the plurality of candidate cells based on the respective measurements, including adjusting at least one of the measurements by the NES offset value; and performing the cell reselection according to the ranking.

Example 3. The method of example 2, wherein: the NES offset value is common to all of the plurality of candidate cells that operate in a NES mode.

Example 4. The method of example 2, wherein: the NES offset value is specific to one of the plurality of candidate cells that operates in an NES mode.

Example 5. The method of example 3 or 4, further comprising: receiving, from the RAN, a listing of the plurality of candidate cells, the listing indicating which of the plurality of candidate cells operate in the NES mode.

Example 6. The method of any of examples 3-5, wherein the NES offset value is negative to lower the ranking of a candidate cell when the candidate cell operates in the NES mode.

Example 7. The method of any of examples 2-6, wherein the ranking includes calculating, for each of the plurality of candidate cells, a respective rank according to R=Qₘₑₐₛ−Qoffset−Qoffsetₜₑₘₚ−Qoffset_{NES}, where: Qₘₑₐₛ is a Reference-Signal-Receive-Power (RSRP) measurement quantity, Qoffset is an offset dependent on whether the candidate cell corresponds to an inter-frequency or intra-frequency neighbor, Qoffsetₜₑₘₚ is a temporarily applied offset, and Qoffset_{NES} is the offset value corresponding to the adjustment in the signal measurement quantity for the cell reselection.

Example 8. The method of any of examples 2-7, wherein: the NES mode is an an Adaption of Discontinuous Transmission (DTX)/Discontinuous Reception (DRX) mode.

Example 9. The method of any of examples 2-8, wherein the performing the cell reselection includes: synchronizing with, and camping on, a highest-ranked cell in the plurality of candidate cells.

Example 10. The method of any of the preceding examples, wherein: the NES offset value is received in a command to release the radio connection, when the UE operates in an active state of the radio connection.

Example 11. The method of any of the preceding examples, wherein: the NES offset value is received via a broadcast.

Example 12. The method of any of the preceding examples, further comprising: receiving, from the RAN, an indication of when a serving cell, in which the UE operates prior to transitioning to the idle mode, starts a NES non-active period; wherein the performing of the measurements is in response to the receiving of the indication.

Example 13. The method of example 12, wherein: the NES non-active period corresponds is an DTX/DRX non-active period.

Example 14. The method of example 12, wherein the indication of when the serving cell starts the NES non-active period is included in a periodic NES configuration.

Example 15. The method of example 14, wherein the periodic NES configuration includes one or both of: a DTX/DRX cycle, or a duration of the DTX/DRX non-active period.

Example 16. The method of any of examples 8-15, wherein the performing of the measurements starts a predetermined number of time units prior to when the NES non-active period starts.

Example 17. The method of any of examples 12-16, wherein the indication of when the serving cell starts the DTX/DRX non-active period is included in one of: (i) a Radio Resource Control (RRC) paging message, (ii) a downlink (DL) Medium Access Control (MAC) control element (CE), or (iii) a Downlink Control Information (DCI).

Example 18. The method of any of examples 12-16, wherein: the indication of when the serving cell starts the NES non-active period is received prior to the UE transitioning to the idle mode.

Example 19. The method of example any of examples 12-16, wherein: the indication of when the serving cell starts the NES non-active period is a system information message transmitted in the serving cell.

Example 20. The method of example any of examples 12-16, wherein: the indication of when the serving cell starts the NES non-active period is a timer value; and the method further comprises: starting a timer with the timer value upon receiving the indication of when the serving cell starts the NES non-active period, and determining that the NES non-active period starts when the timer expires.

Example 21. A user equipment (UE) comprising: a transceiver; and processing hardware; the UE configured to implement a method of any of the preceding examples.

Example 22. A method for cell reselection, the method implemented in a user equipment (UE) and comprising: receiving, from a radio access network (RAN), a network energy saving (NES) offset value for the cell reselection; performing, in an idle state of a radio connection between the UE and the RAN, measurements on a plurality of neighbor cells; ranking the plurality of neighbor cells based on the measurements, including applying the NES offset value to adjust the ranking; performing the cell selection based on the ranking.

Example 23. The method of example 22, wherein: the NES offset value is an indication of when a serving cell, in which the UE operates prior to transitioning to the idle mode, starts a DTX/DRX non-active period.

Example 24. The method of example 22, wherein: the NES offset value corresponds to an adjustment in a signal measurement quantity for the cell reselection.

Example 25. A method for cell reselection, the method implemented in a user equipment (UE) and comprising: receiving, from a radio access network (RAN) and in an idle state of a radio connection between the UE and a serving cell of the RAN, an indication of when the serving cell starts a network energy saving (NES) non-active period; and determining to refrain from performing measurements on a plurality of neighbor cells, based on the indication.

Example 26. The method of example 25, further comprising: monitoring paging in the serving cell during the NES non-active period.

Example 27. The method of example 25, further comprising: refraining from monitoring paging in the serving cell in the NES non-active period.

Example 28. The method of example 27, further comprising: resuming the monitoring of the paging in the serving cell when the NES non-active period ends.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “some” means “one or more”. In some implementations, “at least one” means “one or more”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method for cell reselection, the method implemented in a user equipment (UE) and comprising:
receiving, from a radio access network (RAN), a network energy saving (NES) offset value specific to one of a plurality corresponding to an adjustment in a signal measurement quantity for the cell reselection;
performing, in an idle state of a radio connection between the UE and the RAN, measurements on the plurality of candidate cells; and
performing the cell reselection based on the measurements and the offset value.

2. The method of claim 1, wherein the performing of the cell reselection includes:
ranking the plurality of candidate cells based on the respective measurements, including adjusting a measurement for the one of the plurality of candidate cells by the NES offset value; and
performing the cell reselection according to the ranking.

3. The method of claim 1, further comprising:
receiving, from the RAN, a listing of the plurality of candidate cells, the listing indicating which of the plurality of candidate cells operate in the NES mode.

4. The method of claim 3, wherein the listing is IntraFreqNeighCellList information element (IE) or an IntraFreqNeighCellList IE.

5. The method of claim 1, wherein:
the NES offset value is received in a command to release the radio connection, when the UE operates in an active state of the radio connection.

6. The method of claim 1, wherein:
the NES offset value is received via a broadcast.

7. The method of claim 1, further comprising:
receiving, from the RAN, an indication of when a serving cell, in which the UE operates prior to transitioning to the idle mode, starts a NES non-active period;
wherein the performing of the measurements is in response to the receiving of the indication.

8. The method of claim 7, wherein the indication of when the serving cell starts the NES non-active period is included in a periodic NES configuration.

9. The method of claim 7, wherein the performing of the measurements starts a predetermined number of time units prior to when the NES non-active period starts.

10. The method of claim 9, wherein the indication of when the serving cell starts the NES non-active period is included in one of:
(i) a Radio Resource Control (RRC) paging message,
(ii) a downlink (DL) Medium Access Control (MAC) control element (CE), or
(iii) a Downlink Control Information (DCI).

11. The method of claim 9, wherein:
the indication of when the serving cell starts the NES non-active period is received prior to the UE transitioning to the idle mode.

12. The method of claim 2, wherein:
the indication of when the serving cell starts the NES non-active period is a system information message transmitted in the serving cell.

13. The method of claim 2 any of claims 9-11, wherein:
the indication of when the serving cell starts the NES non-active period is a timer value; and the method further comprises:
starting a timer with the timer value upon receiving the indication of when the serving cell starts the NES non-active period, and
determining that the NES non-active period starts when the timer expires.

14. A user equipment (UE) comprising:
a transceiver; and
processing hardware;
the UE configured to implement a method of claim 1.

15. (canceled)
